(19) United States
(12) Patent Application Publication
(10) Pub. No.: US 2019/0103724 A1
(43) Pub. Date: Apr. 4, 2019

(54) LASER SYSTEM

(71) Applicant: GIGAPHOTON INC., Tochigi (JP)

(72) Inventors: Takashi ONOSE, Oyama-shi (JP); Osamu WAKABAYASHI, Oyama-shi (JP)

(73) Assignee: GIGAPHOTON INC., Tochigi (JP)

(21) Appl. No.: 16/208,815

(22) Filed: Dec. 4, 2018

Related U.S. Application Data
(63) Continuation of application No. PCT/JP2016/071803, filed on Jul. 26, 2016.

(51) Int. Cl. H01S 3/094; H01S 3/00; H01S 3/11

(52) U.S. Cl. CPC H01S 3/094088; H01S 3/094076; H01S 3/2251; H01S 3/11; H01S 3/0057

(57) ABSTRACT

A laser system includes a laser device configured to output pulse laser light, and a first optical pulse stretcher including a delay optical path for stretching a pulse width of the pulse laser light. The first optical pulse stretcher is configured to change a beam waist position of circulation light that circulates through the delay optical path and is output therefrom, in an optical path axis direction according to a circulation count. When the circulation light is condensed by an ideal lens, a light condensing position of the circulation light is changed in the optical path axis direction according to the circulation count.

### CROSS-REFERENCE TO RELATED APPLICATIONS

The present application is a continuation application of International Application No. PCT/JP2016/071803 filed on Jul. 26, 2016. The content of the application is incorporated herein by reference in its entirety.

### BACKGROUND

### 1. Technical Field

The present disclosure relates to a laser system including a laser device and an optical pulse stretcher.

### 2. Related Art

Along with development of micronizing and high integration of semiconductor integrated circuits, an improvement in resolution is required in semiconductor exposure devices. Hereinafter, a semiconductor exposure device will be simply referred to as an “exposure device”. Accordingly, a wavelength of light output from an exposure light source has been shortened. As an exposure light source, a gas laser device is used instead of a conventional mercury lamp. At present, as laser devices for exposure, a KrF excimer laser device that outputs ultraviolet light having a wavelength of 248 nm, and an ArF excimer laser device that outputs ultraviolet light having a wavelength of 193.4 nm are used.

Currently, as an exposure technology, immersion exposure has been put into practice. In the immersion exposure, a space between a projection lens on the exposure device side and a wafer is filled with liquid, whereby the refractive index of the space is changed. Thereby, an apparent wavelength of the light source for exposure is shortened.

In the case where immersion exposure is performed with use of an ArF excimer laser device as a light source for exposure, a wafer is irradiated with ultraviolet light having a wavelength of 134 nm in the water. This technology is called ArF immersion exposure. ArF immersion exposure is also referred to as ArF immersion lithography.

The spectral linewidth in natural oscillation in KrF and ArF excimer laser devices is wide approximately ranging from 350 pm to 400 pm. This causes chromatic aberration of laser light (ultraviolet light) reduced and projected on the wafer by the projection lens on the exposure device side. Thereby, the resolution is lowered. As such, it is necessary to narrow the spectral linewidth of laser light output from a gas laser device to a degree in which chromatic aberration can be disregarded. Accordingly, a laser resonator of a gas laser device is provided with a line narrowing module having a line narrowing element. With the line narrowing module, narrowing of the spectral linewidth is realized. The line narrowing element may be an etalon, a grating, or the like. A laser device in which the spectral linewidth is narrowed as described above is referred to as a line narrowed laser device.

As the laser device, an optical pulse stretcher for stretching a pulse width of laser light is used to reduce a damage on the optical system of the exposure device. An optical pulse stretcher resolves each pulse light beam included in laser light output from the laser device into a plurality of pulse light beams having time differences to thereby lower the peak power level of each pulse light beam.

### CITATION LIST

### Patent Literature

Patent Literature 1: Japanese Patent Application Laid-Open No. 2011-176358
Patent Literature 2: Japanese Patent No. 2760159
Patent Literature 3: Japanese Patent Application Laid-Open No. 11-312631
Patent Literature 4: Japanese Patent Application Laid-Open No. 2012-156531

### SUMMARY

A laser system according to one aspect of the present disclosure may include (A) a laser device and (B) a first optical pulse stretcher. (A) A laser device may be configured to output pulse laser light. (B) A first optical pulse stretcher may include a delay optical path for stretching a pulse width of the pulse laser light. The first optical pulse stretcher may be configured to change a beam waist position of circulation light that circulates through the delay optical path and is output therefrom, in an optical path axis direction according to a circulation count.

### BRIEF DESCRIPTION OF THE DRAWINGS

Some embodiments of the present disclosure will be described below as just examples with reference to the accompanying drawings.

FIG. 1 schematically illustrates a configuration of a laser system according to a comparative example:

FIG. 2 illustrates a positional relation among a beam splitter and first to fourth concave mirrors;

FIG. 3 illustrates output light from an OPS:

FIG. 4 illustrates a configuration of an OPS configured to resolve pulse laser light temporally and spatially:

FIG. 5 illustrates an incident optical path of stretched pulse laser light to an inside of a discharge space;

FIG. 6 illustrates a configuration of a laser system according to a first embodiment;

FIG. 7 illustrates a positional relation among a beam splitter and first to fourth concave mirrors;

FIG. 8 illustrates stretched pulse laser light made incident on an amplifier;

FIG. 9A illustrates zero-circulation light output from an OPS;

FIG. 9B illustrates one-circulation light output from the OPS;

FIG. 9C illustrates two-circulation light output from the OPS:

FIG. 10 illustrates an incident optical path of stretched pulse laser light to an inside of a discharge space:

FIG. 11A is a schematic diagram illustrating a method of measuring a change in a beam waist position of output light from the OPS of the first embodiment:

FIG. 11B illustrates an example of measuring a change in a beam waist position of output light from an OPS of the comparative example;

FIG. 12 illustrates an example of a change in a spot diameter of output light from the OPS;

FIG. 13 illustrates a configuration of an OPS according to a first modification:

FIG. 14 illustrates a configuration of an OPS according to a second modification:

FIG. 15 illustrates a configuration of an OPS used in a laser system according to a second embodiment;

FIG. 16A illustrates zero-circulation light output from the OPS;

FIG. 16B illustrates one-circulation light output from the OPS;

FIG. 17 illustrates two-circulation light output from the OPS;

FIG. 18 is a perspective view illustrating an amplifier and an OPS disposed in a post stage of the amplifier:

FIG. 19 illustrates a configuration of an amplifier according to a first modification; and

FIG. 20 illustrates a configuration of an amplifier according to a second modification.

### EMBODIMENTS

Contents

1. Comparative example

### 1.1 Configuration

### 1.2 Operation

1.3 Definition of pulse width

### 1.4 Problem

1.4.1 Drop of coherence due to spatial resolution

### 2. First Embodiment

### 2.1 Configuration

### 2.2 Operation

### 2.3 Effect

2.4 Beam waist position

### 2.5 Modifications of OPS

2.5.1 First modification
2.5.2 Second modification

### 3. Second Embodiment

### 3.1 Configuration

### 3.2 Operation

### 3.3 Effect

4. Example of disposing OPS in post stage of amplifier
5. Modifications of amplifier
5.1 First modification
5.2 Second modification

Hereinafter, embodiments of the present disclosure will be described in detail with reference to the drawings. The embodiments described below illustrate some examples of the present disclosure, and do not limit the contents of the present disclosure. All of the configurations and the operations described in the embodiments are not always indispensable as configurations and operations of the present disclosure. The same constituent elements are denoted by the same reference signs, and overlapping description is omitted.

### 1. Comparative Example

1.1 Configuration

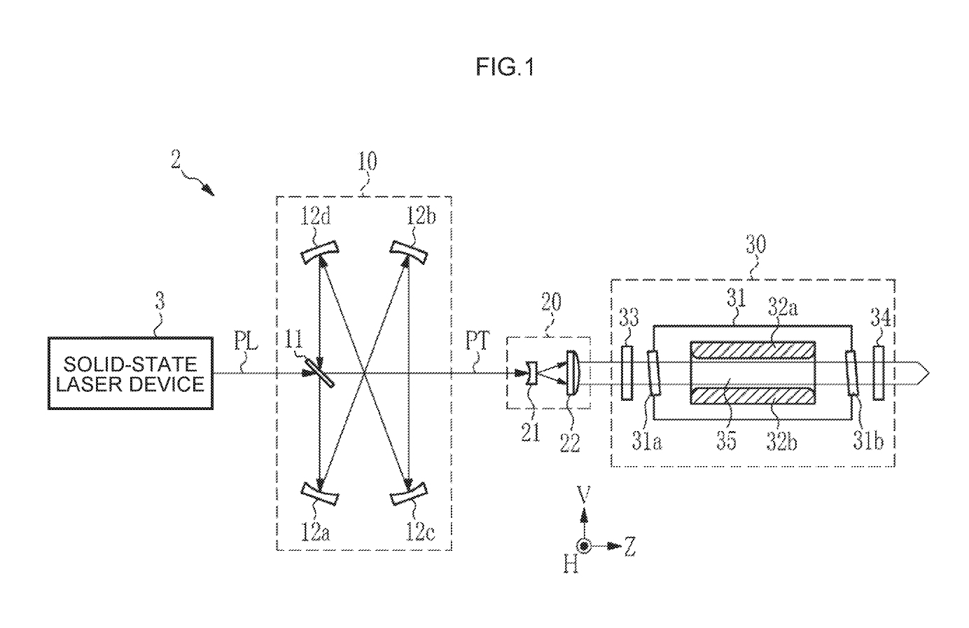

FIG. 1 schematically illustrates a configuration of a laser system 2 according to a comparative example. In FIG. 1, the laser system 2 includes a solid-state laser device 3 as a master oscillator, an optical pulse stretcher (OPS) 10, a beam expander 20, and an amplifier 30.

The solid-state laser device 3 includes a semiconductor laser, an amplifier, nonlinear crystal that are not illustrated, and the like. The solid-state laser device 3 outputs pulse laser light PL in a single lateral mode. The pulse laser light PL is a Gaussian beam having a central wavelength in a wavelength range from 193.1 nm to 193.5 nm, and a spectral linewidth of about 0.3 pm. The solid-state laser device 3 may be a solid-state laser device including a titanium sapphire laser that outputs narrow band pulse laser light having a central wavelength of about 773.4 nm and nonlinear crystal that outputs a fourth harmonic wave.

The OPS 10 includes a beam splitter 11 and first to fourth concave mirrors 12a to 12d. The beam splitter 11 is a partial reflective mirror. The reflectance of the beam splitter 11 is preferably in a range from 40% to 70%, and more preferably, about 60%. The beam splitter 11 is disposed on an optical path of the pulse laser light PL output from the solid-state laser device 3. The beam splitter 11 transmits part of the incident pulse laser light PL, and reflects the remaining part thereof.

The first to fourth concave mirrors 12a to 12d constitute a delay optical path for stretching the pulse width of the pulse laser light PL. All of the first to fourth concave mirrors 12a to 12d have the same radius of curvature R. The first and second concave mirrors 12a and 12b are disposed such that the light having been reflected by the beam splitter 11 is reflected by the first concave mirror 12a and is made incident on the second concave mirror 12b. The third and fourth concave mirrors 12c and 12d are disposed such that the light having been reflected by the second concave mirror 12b is reflected by the third concave mirror 12c and is further reflected by the fourth concave mirror 12d, and is made incident on the beam splitter 11 again.

Each of the distance between the beam splitter 11 and the first concave mirror 12a and the distance between the fourth concave mirror 12d and the beam splitter 11 is equal to a half of the radius of curvature R, that is, R/2. Each of the distance between the first concave mirror 12a and the second concave mirror 12b, the distance between the second concave mirror 12b and the third concave mirror 12c, and the distance between the third concave mirror 12c and the fourth concave mirror 12d, is equal to the radius of curvature R.

All of the first to fourth concave mirrors 12a to 12d have the same focal distance F. The focal distance F is equal to a half of the radius of curvature R, that is, F=R/2. Accordingly, an optical path length L_{OPS} of the delay optical path, configured of the first to fourth concave mirrors 12a to 12d, is eight times longer than the focal distance F. This means that the OPS 10 satisfies a relation of L_{OPS}=8F.

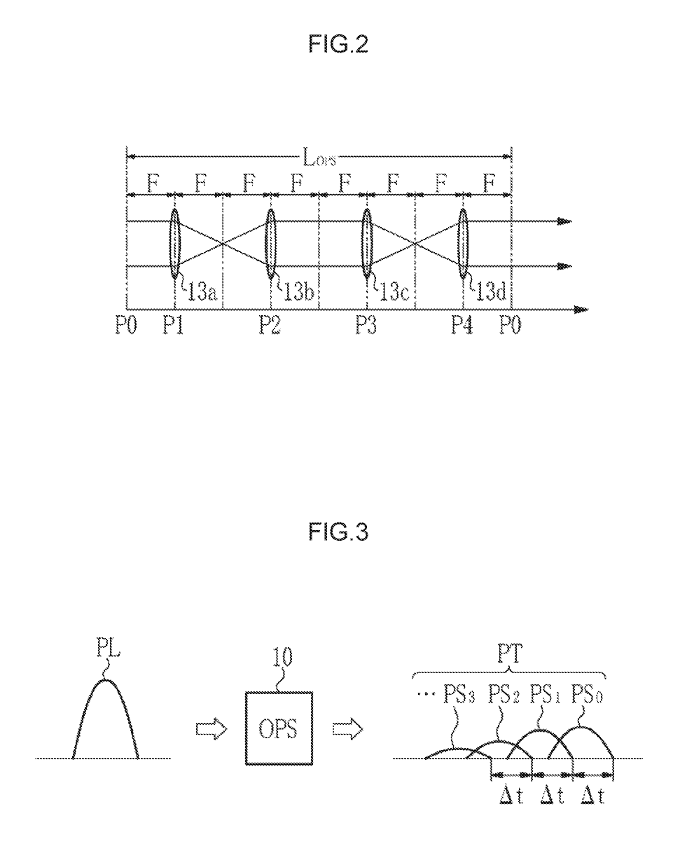

FIG. 2 illustrates a positional relation among the beam splitter 11 and the first to fourth concave mirrors 12a to 12d. In FIG. 2, the first to fourth concave mirrors 12a to 12d are illustrated by being replaced with convex lenses 13a to 13d each having a focal distance F. P0 represents a position of the beam splitter 11. P1 to P4 represent positions of the first to fourth concave mirrors 12a to 12d, respectively.

The delay optical system configured of the first to fourth concave mirrors 12a to 12d is a collimate optical system. Accordingly, when the incident light to the first concave mirror 12a is collimate light, emitted light from the fourth concave mirror 12d is collimate light.

The first to fourth concave mirrors 12a to 12d are disposed such that the optical path length L_{OPS} becomes equal to or longer than a temporally coherent length L_{C} of the pulse laser light PL. The temporally coherent length L_{C} is calculated based on a relational expression of L_{C}=λ²/Δλ. Here, λ represents a central wavelength of the pulse laser light PL. Δλ represents a spectral linewidth of the pulse laser light PL. For example, when λ is 193.35 nm and Δλ is 0.3 pm, L_{C} is 0.125 m.

The beam expander 20 is disposed on the optical path of the stretched pulse laser light PT output from the OPS 10. The stretched pulse laser light PT is light generated by stretching the pulse width of the pulse laser light PL by the OPS 10. The beam expander 20 includes a concave lens 21 and a convex lens 22. The beam expander 20 expands the beam diameter of the stretched pulse laser light PT input from the OPS 10, and outputs it.

The amplifier 30 is disposed on the optical path of the stretched pulse laser light PT output from the beam expander 20. The amplifier 30 is an excimer laser device including a laser chamber 31, a pair of discharge electrodes 32a and 32b, a rear mirror 33, and an output coupling mirror 34. The rear mirror 33 and the output coupling mirror 34 are partial reflective mirrors, and constitute a Fabry-Perot resonator. Each of the rear mirror 33 and the output coupling mirror 34 is coated with a film partially reflecting light of a laser oscillation wavelength. The reflectance of the partial reflecting film of the rear mirror 33 ranges from 80% to 90%. The reflectance of the partial reflecting film of the output coupling mirror 34 ranges from 20% to 40%.

The laser chamber 31 is filled with a laser medium such as ArF gas. The pair of discharge electrodes 32a and 32b is disposed in the laser chamber 31 as electrodes for exciting the laser medium through discharge. Between the pair of discharge electrodes 32a and 32b, pulse-state high voltage is applied from a power source not illustrated.

Hereinafter, a traveling direction of the stretched pulse laser light PT output from the beam expander 20 is referred to as a Z direction. A discharge direction between the pair of discharge electrodes 32a and 32b is referred to as a V direction. The V direction is orthogonal to the Z direction. A direction orthogonal to the Z direction and the V direction is referred to as an H direction.

The laser chamber 31 is provided with windows 31a and 31b at both ends thereof. The stretched pulse laser light PT output from the beam expander 20 passes through the rear mirror 33 and the window 31a, and is made incident, as seed light, on the discharge space 35 between the pair of discharge electrodes 32a and 32b. The width in the V direction of the discharge space 35 is approximately equal to the beam diameter expanded by the beam expander 20.

The solid-state laser device 3 and the amplifier 30 are controlled by a synchronization control unit not illustrated. The amplifier 30 is controlled by the synchronization control unit to perform discharging at the timing when the stretched pulse laser light PT is made incident on the discharge space 35.

1.2 Operation

Next, operation of the laser system 2 according to the comparative example will be described. First, the pulse laser light PL output from the solid-state laser device 3 is made incident on the beam splitter 11 in the OPS 10. Part of the pulse laser light PL having been made incident on the beam splitter 11 passes through the beam splitter 11, and is output from the OPS 10 as zero-circulation light PS₀ that did not circulate through the delay optical path.

Reflected light reflected by the beam splitter 11, of the pulse laser light PL having been made incident on the beam splitter 11, enters the delay optical path, and is reflected by the first concave mirror 12a and the second concave mirror 12b. An optical image of reflected light in the beam splitter 11 is formed as a first transfer image of equal magnification by the first and second concave mirrors 12a and 12b. Then, a second transfer image of equal magnification is formed at a position of the beam splitter 11 by the third concave mirror 12c and the fourth concave mirror 12d.

Part of the light made incident on the beam splitter 11 as the second transfer image is reflected by the beam splitter 11, and is output from the OPS 10 as one-circulation light PS₁ that circulated through the delay optical path once. The one-circulation light PS₁ is output while being delayed by a delay time Δt from the zero-circulation light PS₀. At is represented as Δt=L_{OPS}/c. Here, c represents velocity of light.

Transmitted light that passed through the beam splitter 11, of the light having been made incident on the beam splitter 11 as the second transfer image, enters the delay optical path again, is reflected by the first to fourth concave mirrors 12a to 12d, and is made incident on the beam splitter 11 again. The reflected light reflected by the beam splitter 11 is output from the OPS 10 as two-circulation light PS₂ that circulated through the delay optical path twice. The two-circulation light PS₂ is output while being delayed by a delay time Δt from the one-circulation light PS₁.

Thereafter, circulation of light on the delay optical path is repeated. Thereby, pulse light is output sequentially from the OPS 10 as three-circulation light PS₃, four-circulation light PS₄, and the like. Light intensity of the pulse light output from the OPS 10 drops as a circulation count on the delay optical path increases.

As illustrated in FIG. 3, as a result that the pulse laser light PL is made incident on the OPS 10, the pulse laser light PL is resolved into a plurality of pulse light beams PS₀, PS₁, PS₂, and the like having time differences, and output therefrom. In FIG. 3, the horizontal axis shows time and the vertical axis shows intensity of light. The stretched pulse laser light PT described above is composed of the plurality of pulse light beams PSₙ (n=0, 1, 2, . . . ) that are formed such that the pulse laser light PL is resolved by the OPS 10. Here, n represents the circulation count on the delay optical path.

As the optical path length L_{OPS} is equal to or longer than the temporally coherent length L_{C}, mutual coherence of the plurality of pulse light beams PSₙ drops. Accordingly, coherence of the stretched pulse laser light PT configured of the plurality of pulse light beams PSₙ drops.

The stretched pulse laser light PT output from the OPS 10 is made incident on the beam expander 20, and the beam diameter thereof is expanded by the beam expander 20, and the stretched pulse laser light is output. The stretched pulse laser light PT output from the beam expander 20 is made incident on the amplifier 30. The stretched pulse laser light PT made incident on the amplifier 30 passes through the rear mirror 33 and the window 31a, and is made incident, as seed light, on the discharge space 35.

In the discharge space 35, discharge is caused by a power source not illustrated in synchronization with incidence of the stretched pulse laser light PT. When the stretched pulse laser light PT passes through the discharge space 35 excited by the discharge, stimulated emission is caused, whereby amplification is performed. Then, the amplified stretched pulse laser light PT is oscillated by the optical resonator, and is output from the output coupling mirror 34.

Consequently, the stretched pulse laser light PT in which the peak power level is lowered and the coherence is lowered, compared with the pulse laser light PL output from the solid-state laser device 3, is output from the laser system 2.

1.3 Definition of Pulse Width

The pulse width TIS of the laser light is defined by Expression 1 provided below. Here, t represents time. I(t) represents intensity of light at the time t. The pulse width of the stretched pulse laser light PT is calculated with use of Expression 1.

$$[ Expression 1 ]$$

$$TIS = \frac{{[ \int I ( t ) dt ]}^{2}}{\int {I ( t )}^{2} dt} \qquad ( 1 )$$

1.4 Problem

Next, problems of the laser system 2 according to the comparative example will be described. It is preferable that coherence of the laser light supplied from the laser system 2 to the exposure device is as low as possible. Accordingly, it is required to further lower the coherence.

1.4.1 Drop of Coherence Due to Spatial Resolution

In the laser system 2 according to the comparative example, the pulse laser light PL is temporally resolved by the OPS 10 to thereby lower the coherence. It is possible to further lower the coherence by spatially resolving the pulse laser light PL.

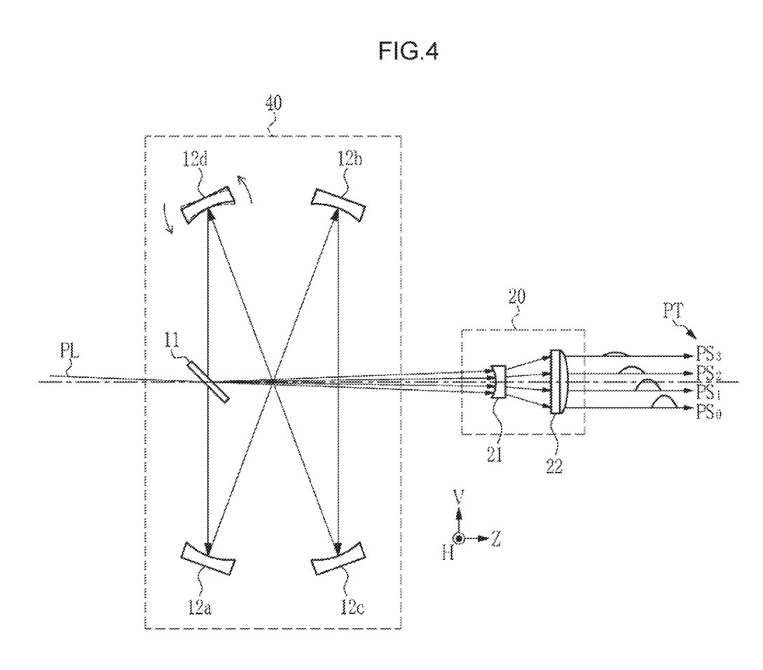

FIG. 4 illustrates a configuration of an OPS 40 that enables the pulse laser light PL to be resolved temporally and spatially. The configuration of the OPS 40 is the same as that of the OPS 10 except for the layout of the fourth concave mirror 12d.

In FIG. 4, the fourth concave mirror 12d is disposed at a position where it is slightly turned with the H direction being the turning axis, relative to the position of the fourth concave mirror 12d of the OPS 10 illustrated by a broken line. With this configuration, an emission angle of each of a plurality of pulse light beams PSₙ output from the OPS 40 is changed in the V direction according to the circulation count “n” on the delay optical path. This means that the plurality of pulse light beams PSₙ output from the OPS 40 have optical path axes that are different from each other. Consequently, the plurality of pulse light beams PSₙ output from the OPS 40 are spatially resolved in the V direction and are made incident on the beam expander 20. In FIG. 4, the incidence direction of the pulse laser light PL to the OPS 40 is slightly tilted from the Z direction.

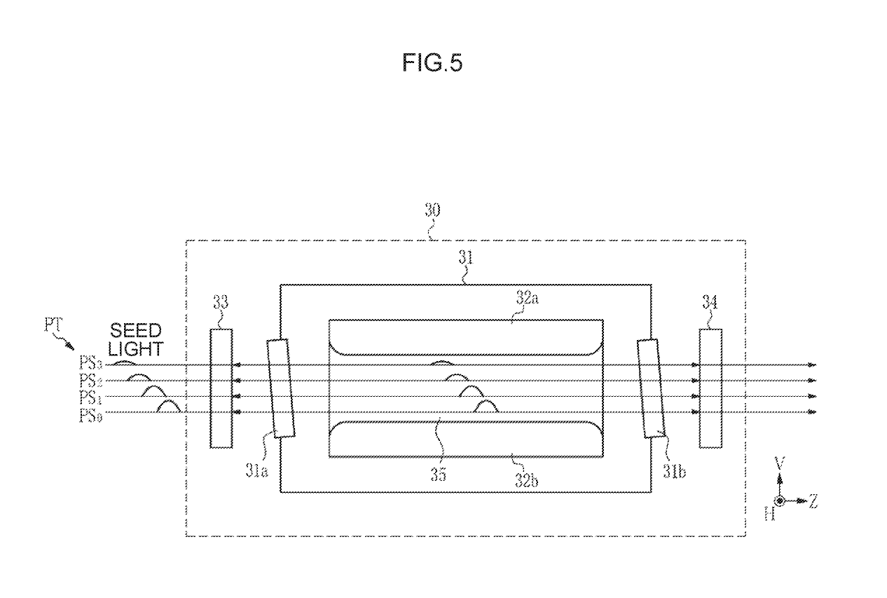

FIG. 5 illustrates an optical path on which the plurality of pulse light beams PSₙ output from the beam expander 20 are made incident on the discharge space 35 of the amplifier 30 as seed light. As described above, the plurality of pulse light beams PSₙ pass through different optical paths in the discharge space 35 according to the circulation count n on the delay optical path. The OPS 40 generates the plurality of pulse light beams PSₙ that are generated by resolving the pulse laser light PL temporally and spatially. Accordingly, coherence of the output light from the amplifier 30 is further lowered.

However, when the pulse laser light PL is resolved temporally and spatially as described above, the discharge space 35 will never be filled with seed light temporally simultaneously regarding the V direction. For example, in a space where the zero-circulation light PS₀ is made incident in the discharge space 35, seed light exists only when the zero-circulation light PS₀ is made incident. Accordingly, at the time when circulation light of the one-circulation light PS₁ and after is made incident, no seed light exists on the optical path of the zero-circulation light PS₀.

In the amplifier 30 that is an excimer laser, an upper level life that is a life of an atom excited to an upper level is as short as about 2 ns. Accordingly, when there is a space not filled with seed light in the discharge space 35, in such a space, spontaneous emission is caused before stimulated emission by seed light is caused. As a result, a large amount of amplified spontaneous emission (ASE) light is included as noise in the output light from the amplifier 30, besides amplified light generated by stimulated emission.

Accordingly, although the output light from the amplifier 30 has lower coherence in the case of using the OPS 40 configured as illustrated in FIG. 4, there is a problem that ASE light is increased. In order to suppress generation of the ASE light, it may be possible to increase the reflectance of the optical resonator of the amplifier 30 so as to increase the seed light existing in the optical resonator. However, when the reflectance of the optical resonator is increased, the energy in the optical resonator is increased, which may cause damage on the optical elements.

In order to suppress generation of the ASE light, it may be possible to increase the pulse width of the stretched pulse laser light PT. However, when the pulse width of the stretched pulse laser light PT is increased, the optical intensity of the seed light is lowered and components not contributing to amplification are increased. Therefore, a larger amount of ASE light may be generated.

### 2. First Embodiment

Next, a laser system according to a first embodiment of the present disclosure will be described. A laser system according to the first embodiment is the same as the laser system of the comparative example illustrated in FIG. 1 except for the configuration of an OPS. In the below description, components that are almost similar to the constituent elements of the laser system of the comparative example illustrated in FIG. 1 are denoted by the same reference signs and the description thereof is omitted as appropriate.

2.1 Configuration

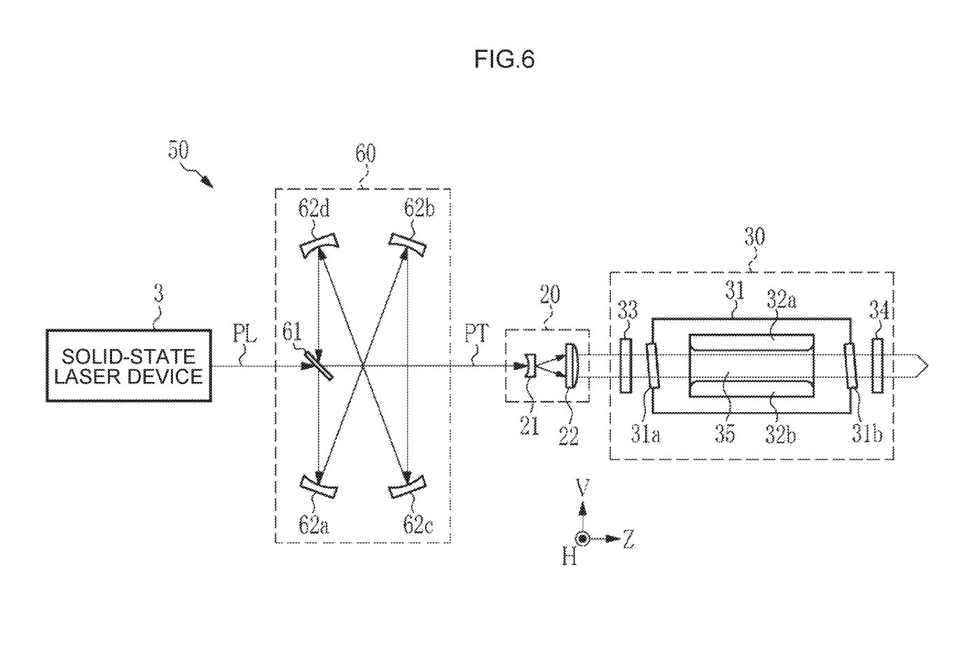

FIG. 6 schematically illustrates a configuration of a laser system 50 according to the first embodiment. The laser system 50 includes a solid-state laser device 3, an OPS 60, a beam expander 20, and an amplifier 30. The OPS 60 includes a beam splitter 61 and first to fourth concave mirrors 62a to 62d. The beam splitter 61 has the same configuration as that of the beam splitter 11 of the comparative example.

Only the fourth concave mirror 62d among the first to fourth concave mirrors 62a to 62d has a different radius of curvature of the mirror from those of the others. Specifically, relationships of R₁=R₂=R₃=R and R₄<R are satisfied, where R₁ represents the radius of curvature of the first concave mirror 62a, R₂ represents the radius of curvature of the second concave mirror 62b, R₃ represents the radius of curvature of the third concave mirror 62c, and R₄ represents the radius of curvature of the fourth concave mirror 62d. Further, relationships of F₁=F₂=F₃=F and F₄<F are satisfied, where F₁ represents the focal distance of the first concave mirror 62a. F₂ represents the focal distance of the second concave mirror 62b, F₃ represents the focal distance of the third concave mirror 62c, and F₄ represents the focal distance of the fourth concave mirror 62d.

Layout of the first to fourth concave mirrors 62a to 62d is similar to that of the comparative example. Each of the distance between the beam splitter 61 and the first concave mirror 62a and the distance between the fourth concave mirror 62d and the beam splitter 61 is equal to a half of the radius of curvature R of the first to third concave mirrors 62a to 62c, that is, R/2. Each of the distance between the first concave mirror 62a and the second concave mirror 62b, the distance between the second concave mirror 62b and the third concave mirror 62c, and the distance between the third concave mirror 62c and the fourth concave mirror 62d is equal to the radius of curvature R.

Accordingly, an optical path length L_{OPS} of the delay optical path, configured of the first to fourth concave mirrors 62a to 62d, is eight times longer than the focal distance F of the first to third concave mirrors 62a to 62c, that is, L_{OPS}=8F. The beam splitter 11 and the first to fourth concave mirrors 12a to 12d are disposed such that the optical path axis of the zero-circulation light PS₀ output from the OPS 60 and the optical path axis of the one-circulation light PS₁ coincide with each other. This means that in the first embodiment, all of the optical path axes of a plurality of pulse light beams PSₙ output from the OPS 60 coincide with one another.

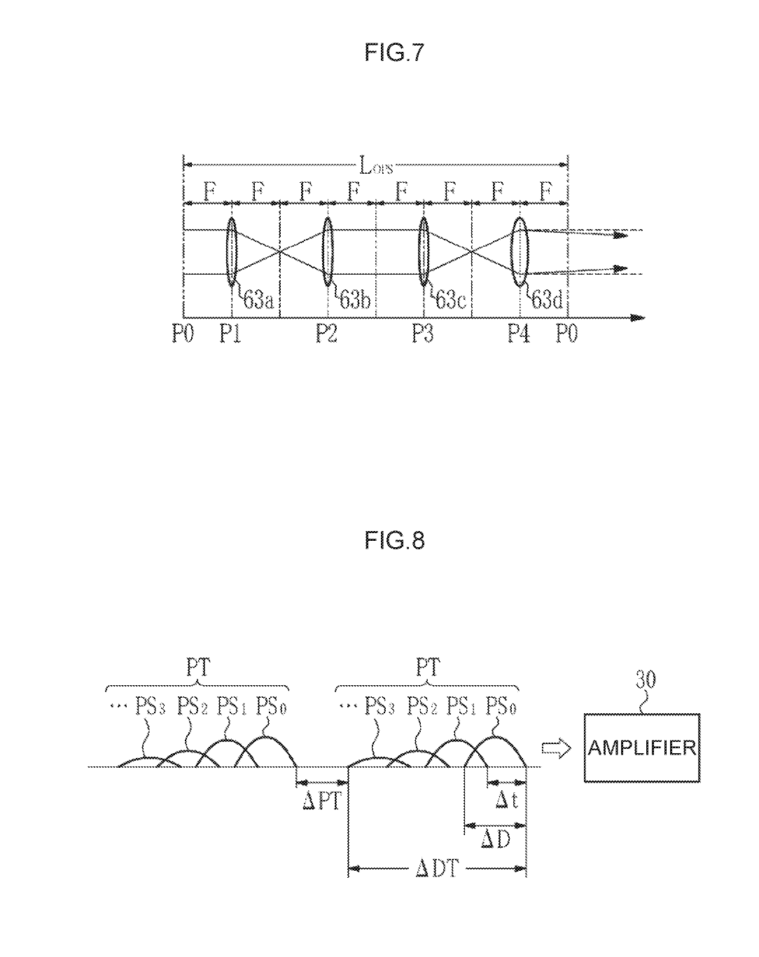

FIG. 7 illustrates a positional relation among the beam splitter 61 and the first to fourth concave mirrors 62a to 62d. In FIG. 7, the first to fourth concave mirrors 62a to 62d are illustrated by being replaced with convex lenses 63a to 63c each having a focal distance F and a convex lens 63d having a focal distance shorter than the focal distance F. P0 represents a position of the beam splitter 61. P1 to P4 represent positions of the first to fourth concave mirrors 62a to 62d, respectively.

While L_{OPS}=8F is satisfied. F1=F2=F3=F and F₄<F are satisfied. Accordingly, the delay optical system is a non-collimate optical system not satisfying the collimate condition. As such, when incident light to the first concave mirror 62a is collimate light, emitted light from the fourth concave mirror 62d is non-collimate light.

The OPS 60 resolves the pulse laser light PL made incident from the solid-state laser device 3 into a plurality of pulse light beams PSₙ (n=0, 1, 2, . . . ) having time differences, and outputs them as stretched pulse laser light PT, similar to the OPS 10 of the comparative example as illustrated in FIG. 3. The pulse laser light PL is Gaussian beam. As such, a divergence angle θₙ of each of the plurality of pulse light beams PSₙ output from the OPS 60 varies according to the circulation count n on the delay optical path. Further, a beam waist position w of each of the plurality of pulse light beams PSₙ moves in the Z direction according to the circulation count n on the delay optical path. The divergence angle θₙ and the beam waist position wₙ are in an inverse proportional relation. The divergence angle θₙ and the beam waist position wₙ are determined according to the curvature of the fourth concave mirror 62d.

The beam waist position is a position where the beam spot size becomes the smallest, which coincides with the position where the radius of curvature of a wave surface becomes flat. The divergence angle represents an angle spread of the beam at a position sufficiently distant from the beam waist position.

As illustrated in FIG. 8, the stretched pulse laser light PT is cyclically made incident on the amplifier 30. In order to suppress generation of ASE light, it is preferable that an interval ΔPT between stretched pulse laser light PT is shorter than the upper level life that is a life of an atom excited to an upper level in the amplifier 30. The upper level life is about 2 ns. Accordingly, it is only necessary that the pulse width ΔDT of the stretched pulse laser light PT is increased as long as possible. The interval ΔPT is a period in which the light intensity is almost zero. For example, when the light intensity is equal to or lower than 1% of the peak intensity, it is determined that the light intensity is zero.

In order to increase the pulse width ΔDT, it is preferable to set the optical path length L_{OPS} such that the delay time Δt coincides with the pulse width ΔD of the pulse laser light PL. In that case, the optical path length L_{OPS} may be set to satisfy Expression 2 provided below.

L_{OPS}=c*ΔD (2)

The pulse width ΔD is almost the same as each pulse width of the plurality of pulse light beams PSₙ. For example, when it is assumed that ΔD is equal to 3 nm, L_{OPS} is equal to 1 m. Then, the optical path length L_{OPS} becomes equal to or longer than the temporally coherent length L_{C}.

Further, in order to suppress generation of ASE light, it is preferable that the pulse width ΔDT of the stretched pulse laser light PT satisfies Expression 3 provided below, where Lₐₘₚ represents the optical path length of an optical resonator of the amplifier 30. The optical path length Lₐₘₚ of the optical resonator is two times a resonator length Lₐ that is a distance between the rear mirror 33 and the output coupling mirror 34, that is. Lₐₘₚ=²Lₐ.

ΔDT≥Lₐₘₚ/c (3)

2.2 Operation

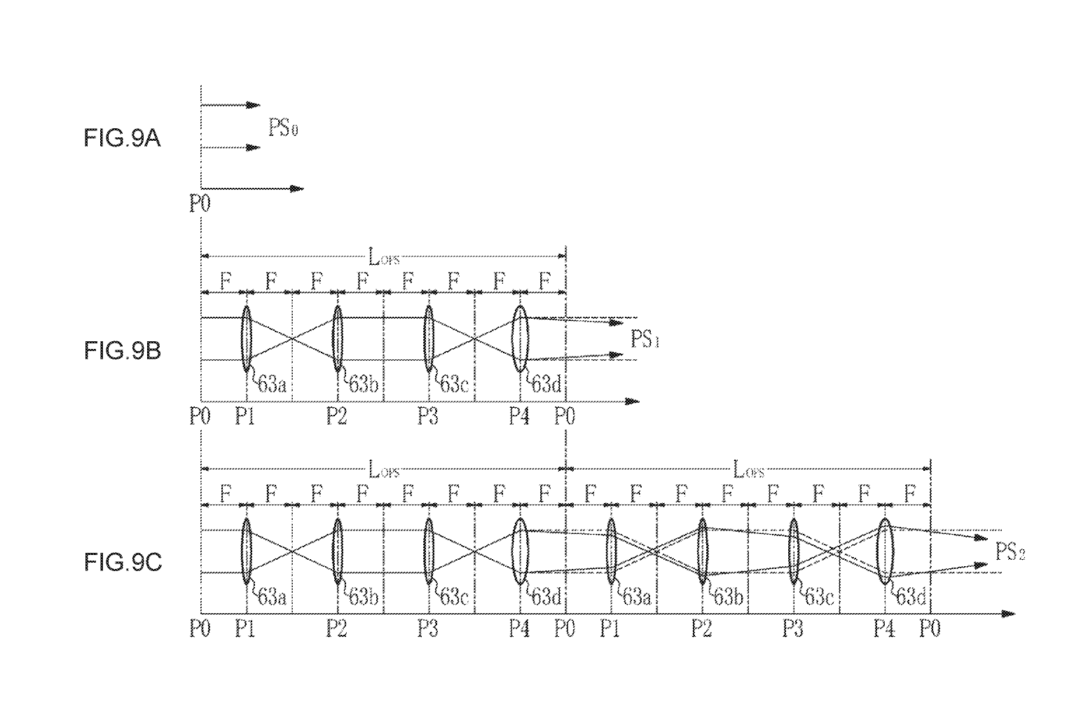

Next, operation of the laser system 50 according to the first embodiment of the present disclosure will be described. First, the pulse laser light PL output from the solid-state laser device 3 is made incident on the beam splitter 61 in the OPS 60. Part of the pulse laser light PL made incident on the beam splitter 61 passes through the beam splitter 61, and is output from the OPS 60 as zero-circulation light PS₀. FIG. 9A illustrates the zero-circulation light PS₀ output from the OPS 60. Zero-circulation light PS₀ is collimate light.

Reflected light reflected by the beam splitter 61, of the pulse laser light PL having been made incident on the beam splitter 61, enters the delay optical path configured of the first to fourth concave mirrors 62a to 62d, and circulates through the delay optical path once, and is made incident on the beam splitter 61 again. Part of the light made incident on the beam splitter 61 is reflected by the beam splitter 61, and is output from the OPS 60 as one-circulation light PS₁. FIG. 9B illustrates the one-circulation light PS₁ output from the OPS 60. As described above, as the delay optical system is a non-collimate optical system, the one-circulation light PS₁ becomes non-collimate light, and converges at a position far from the OPS 60. This means that the beam waist position w₁ of the one-circulation light PS₁ is located far from the OPS 60.

Transmitted light that passed through the beam splitter 61, of the light having been made incident on the beam splitter 61, enters the delay optical path again, circulates through the delay optical path once again, and is made incident on the beam splitter 61 again. Part of the light made incident on the beam splitter 61 is reflected by the beam splitter 61, and is output from the OPS 60 as two-circulation light PS₂. FIG. 9C illustrates the two-circulation light PS₂ output from the OPS 60. The beam waist position w₂ of the two-circulation light PS₂ is closer to the OPS 60 side than the beam waist position w₁ of the one-circulation light PS₁.

Subsequently, circulation of light on the delay optical path is repeated. Thereby, pulse light is output sequentially from the OPS 60 as three-circulation light PS₃, four-circulation light PS₄, and the like. As the circulation count n on the delay optical path increases, the beam waist position wₙ of the output light from the OPS 60 is closer to the OPS 60 side.

As a result that the pulse laser light PL is made incident on the OPS 60, the pulse laser light PL is resolved into a plurality of pulse light beams PSₙ (n=0, 1, 2, . . . ) having time differences, and output. The plurality of pulse light beams PSₙ constitute the stretched pulse laser light PT.

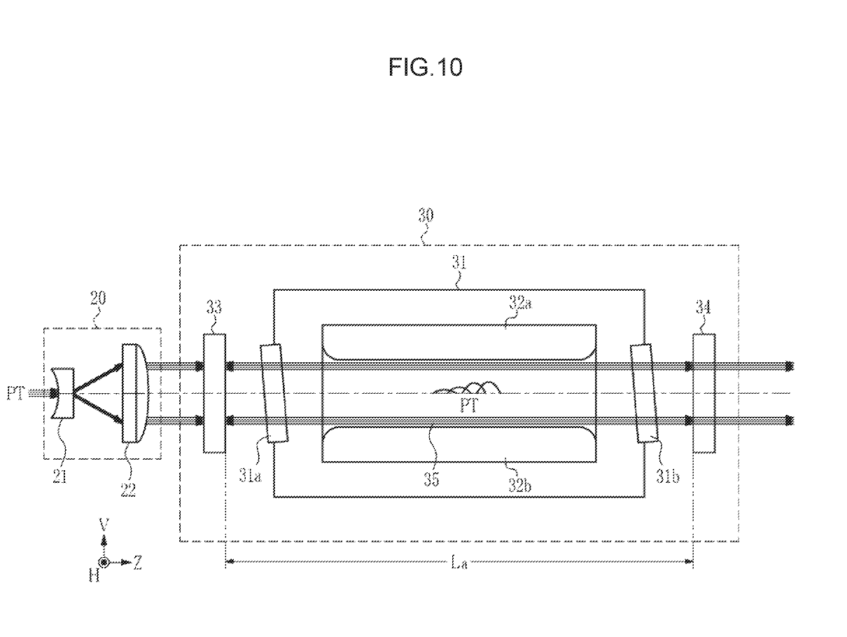

As illustrated in FIG. 10, the beam diameter of the stretched pulse laser light PT is expanded by the beam expander 20 such that the beam diameter becomes equal to the width of the discharge space 35, and the stretched pulse laser light PT is made incident on the amplifier 30 as seed light. The stretched pulse laser light PT made incident on the amplifier 30 passes through the rear mirror 33 and the window 31a, and is made incident on the discharge space 35. As the respective pulse light beams PSₙ have optical path axes that coincide with each other, they overlap each other in the discharge space 35.

In the discharge space 35, discharge is caused by a power source not illustrated in synchronization with incidence of the stretched pulse laser light PT. When the stretched pulse laser light PT passes through the discharge space 35 excited by the discharge, stimulated emission is caused, whereby amplification is performed. Then, the amplified stretched pulse laser light PT is oscillated by the optical resonator, and is output from the output coupling mirror 34.

2.3 Effect

The OPS 60 temporally resolves the pulse laser light PL, and additionally, changes the beam waist position wₙ of each of the resolved pulse light beams PSₙ in the optical path axis direction without changing the traveling direction. Thereby, the plurality of pulse light beams PSₙ have different beam waist positions w and the divergence angles θₙ, respectively. Accordingly, the mutual coherence is further reduced. Therefore, coherence of the stretched pulse laser light PT configured thereof is further reduced.

Further, the plurality of pulse light beams PSₙ made incident on the discharge space 35 as seed light overlap each other in the discharge space 35. Accordingly, the discharge space 35 is filled with seed light temporally simultaneously in the V direction. Thereby, generation of ASE light is suppressed.

Moreover, as the pulse width ΔDT of the stretched pulse laser light PT is set to satisfy Expression 3 described above, the discharge space 35 is filled with seed light at any time in the discharge period. Accordingly, generation of ASE light is further suppressed.

Accordingly, the laser system 50 of the first embodiment is able to lower the coherence of output light, and to suppress generation of ASE light.

2.4 Beam Waist Position

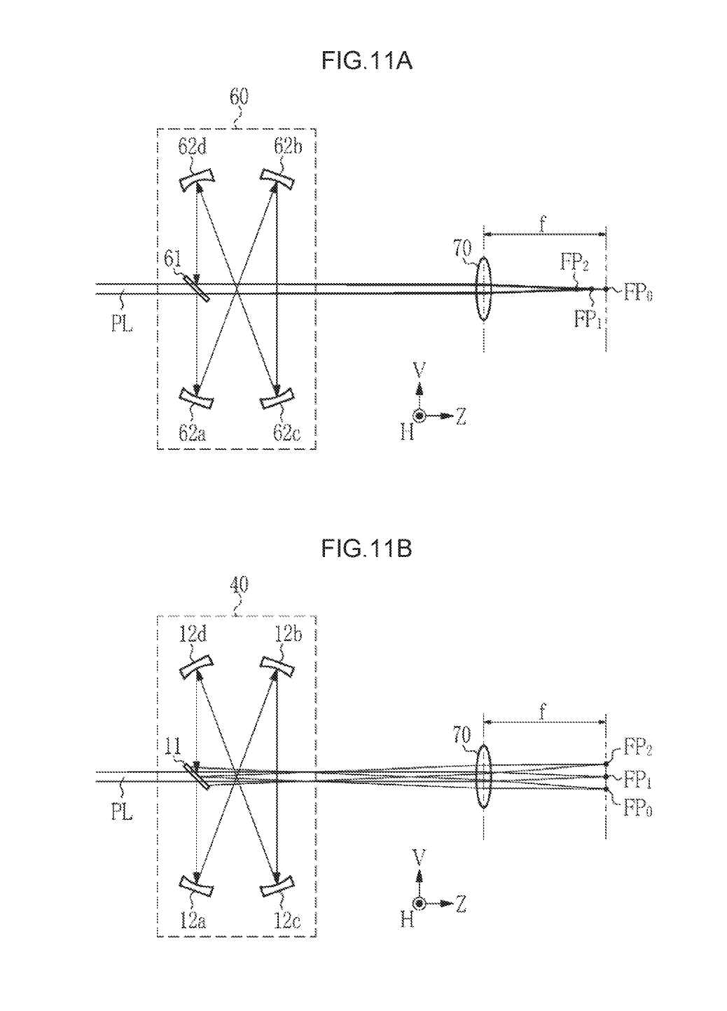

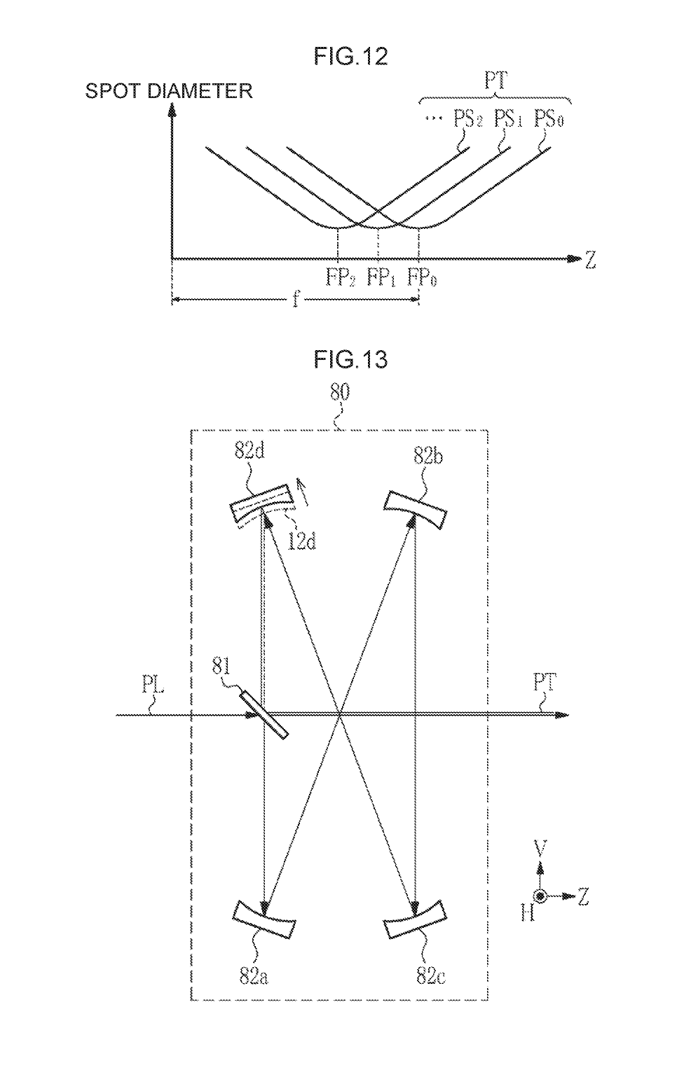

FIG. 11A is a schematic diagram illustrating a method of measuring changes in the beam waist positions w of the plurality of pulse light beams PSₙ output from the OPS 60 of the first embodiment. An ideal lens 70 having a focal distance f is disposed on the optical path axis of output light of the OPS 60, and a light condensing position of the output light by the ideal lens 70 is measured. The light condensing position corresponds to a beam waist position. The ideal lens 70 is a lens in which aberration can be ignored. The light condensing position is obtained by measuring the position where the beam spot diameter becomes minimum, as illustrated in FIG. 12.

As the zero-circulation light PS₀ is collimate light, a light condensing position FP₀ by the ideal lens 70 coincides with the focal position of the ideal lens 70. A light condensing position FP₁ of the one-circulation light PS₁ by the ideal lens 70 moves to the ideal lens 70 side from the light condensing position FP₀. A light condensing position FP₂ of the two-circulation light FP₂ by the ideal lens 70 moves to the ideal lens 70 side from the light condensing position FP₁. Thereafter, the light condensing position comes closer to the ideal lens 70 side as the circulation count n increases, in a similar manner.

FIG. 11B illustrates an example of measuring the beam waist position wₙ of the plurality of pulse light beams PSₙ output from the OPS 40 described as a comparative example. The OPS 40 changes the traveling direction of the plurality of pulse light beams PSₙ. Accordingly, the light condensing positions FP₀, FP₁, FP₂, . . . sequentially move in the V direction.

The first embodiment is set such that the delay optical system becomes non-collimate optical system by changing the curvature of the fourth concave mirror 62d among the first to fourth concave mirrors 62a to 62d constituting the delay optical system. It is also possible to change the curvature of another concave mirror, not limiting to the fourth concave mirror 62d.

The number of concave mirrors constituting the delay optical system is not limited to four. Moreover, the number of concave mirrors in which the curvature is changed is not limited to one. Accordingly, it is only necessary to allow the delay optical system to be a non-collimate optical system by changing the curvature of at least one concave mirror among a plurality of concave mirrors constituting the delay optical system, from the others.

2.5 Modifications of OPS

Next, other examples for allowing the delay optical system to be a non-collimate optical system will be described.

2.5.1 First Modification

FIG. 13 illustrates a configuration of an OPS 80 according to a first modification. The OPS 80 includes a beam splitter 81 and first to fourth concave mirrors 82a to 82d. The beam splitter 81 has the same configuration as that of the beam splitter 11 of the comparative example.

All of the first to fourth concave mirrors 82a to 82d have the same radius of curvature R. All of the first to fourth concave mirrors 82a to 82d have the same focal distance F. The configuration of the OPS 80 is the same as that of the OPS 10 of the comparative example except for the layout of the fourth concave mirror 82d.

In FIG. 13, the fourth concave mirror 82d is moved from the position of the fourth concave mirror 12d of the OPS 10 illustrated by a broken line, in a direction of elongating the optical path length L_{OPS} of the delay optical path. Specifically, the distance between the third concave mirror 82c and the fourth concave mirror 82d is made longer more than two times the focal distance F, and the distance between the fourth concave mirror 82d and the beam splitter 81 is made longer than the focal distance F. This means that the OPS 80 satisfies a relation of L_{OPS}>8F.

As the delay optical system configured of the first to fourth concave mirrors 82a to 82d is a non-collimate optical system, circulation light that circulated through the delay optical path becomes non-collimate light. In each of the plurality of pulse light beams PSₙ output from the OPS 80, a divergence angle θₙ varies according to the circulation count n on the delay optical path, and the beam waist position wₙ is moved in the Z direction. The optical path axes of the plurality of pulse light beams PSₙ are almost the same.

Among the first to fourth concave mirrors 82a to 82d, a concave mirror to be moved in a direction of elongating the optical path length L_{OPS} is not limited to the fourth concave mirror 82d. The concave mirror to be moved may be a mirror other than the fourth concave mirror 82d. It is only necessary that among the concave mirrors constituting the delay optical system, at least one concave mirror is moved from a position satisfying the collimate condition in a direction of changing the optical path length of the delay optical path.

2.5.2 Second Modification

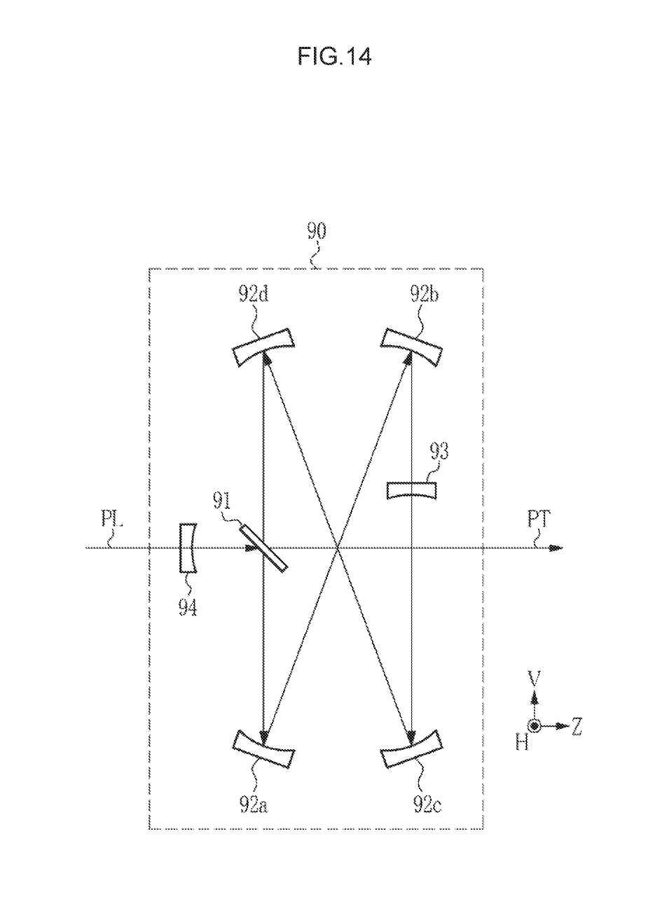

FIG. 14 illustrates a configuration of an OPS 90 according to a second modification. The OPS 90 includes a beam splitter 91, first to fourth concave mirrors 92a to 92d, a first lens 93, and a second lens 94. The beam splitter 91 has the same configuration as that of the beam splitter 11 of the comparative example. The first to fourth concave mirrors 92a to 92d have the same configurations as those of the first to fourth concave mirrors 12a to 12d of the comparative example, and are disposed at the same positions. This means that the OPS 90 satisfies a relation of L_{OPS}=8F.

The first lens 93 and the second lens 94 are made of synthetic quartz or calcium fluoride (CaF₂). The first lens 93 is disposed on an optical path between the second concave mirror 92b and the third concave mirror 92c. The first lens 93 is a concave lens, and changes the divergence angle of the incident light and emits it. It is set that the delay optical system becomes a non-collimate optical system by the first lens 93.

The second lens 94 is disposed on an optical path of the pulse laser light PL made incident on the beam splitter 91. The second lens 94 is a concave lens, and is provided to correct the divergence angle changed by the first lens 93. The second lens 94 is not an indispensable configuration, and may be omitted.

As the delay optical system configured of the first to fourth concave mirrors 92a to 92d and the first lens 93 is a non-collimate optical system, circulation light that circulated through the delay optical path becomes non-collimate light. In each of the plurality of pulse light beams PSₙ output from the OPS 90, the divergence angle θₙ varies according to the circulation count n on the delay optical path, and the beam waist position wₙ is moved in the Z direction. The optical path axes of the plurality of pulse light beams PSₙ are almost the same.

The position of the first lens 93 is not limited to a position on the optical path between the second concave mirror 92b and the third concave mirror 92c. The first lens 93 may be disposed on an optical path between the fourth concave mirror 92d and the beam splitter 91, or on an optical path between the beam splitter 91 and the first concave mirror 92a.

Each of the first and second lenses 93 and 94 is not limited to a concave lens, and may be configured of an optical element other than a concave lens. For example, each of the first and second lenses 93 and 94 may be a cylindrical lens. Moreover, each of the first and second lenses 93 and 94 may be one configured of a combination of two cylindrical lenses in which the curved directions thereof are orthogonal to each other.

### 3. Second Embodiment

Next, a laser system according to a second embodiment of the present disclosure will be described. A laser system according to the second embodiment is the same as the laser system 50 of the first embodiment illustrated in FIG. 6, except for the configuration of an OPS. In the first embodiment, the OPS includes a plurality of concave mirrors. In the second embodiment, an OPS includes a plurality of condensing lenses.

3.1 Configuration

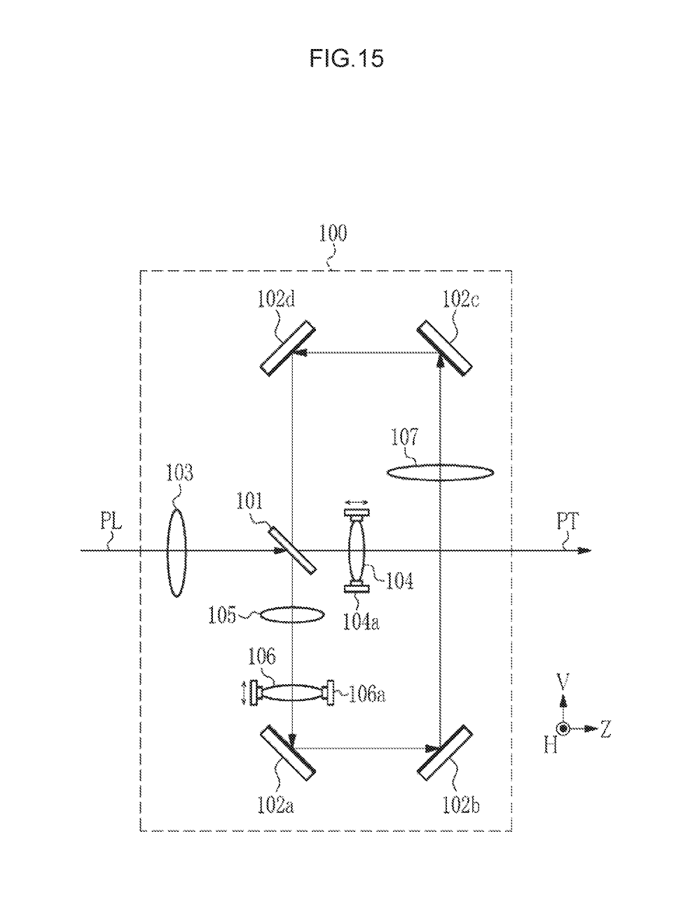

FIG. 15 illustrates a configuration of an OPS 100 used in a laser system of the second embodiment. The OPS 100 includes a beam splitter 101, first to fourth high reflective mirrors 102a to 102d, and first to fifth condensing lenses 103 to 107. The beam splitter 101 has the same configuration as that of the beam splitter 61 of the first embodiment. The first to fifth condensing lenses 103 to 107 are convex lenses.

The first and second condensing lenses 103 and 104 constitute a first lens group for adjusting the divergence angle θ₀ of the zero-circulation light PS₀. The first condensing lens 103 is disposed on an optical path of the pulse laser light PL made incident from the solid-state laser device 3 up to the position where it enters the beam splitter 101. The second condensing lens 104 is disposed on an optical path of light that passed through the beam splitter 101 out of the pulse laser light PL.

The second condensing lens 104 is held by a uniaxial stage 104a. The uniaxial stage 104a enables the second condensing lens 104 to move in the Z axis direction that is an optical path axis direction. The divergence angle θ₀ of the zero-circulation light PS₀ can be adjusted by adjusting the position of the second condensing lens 104 with respect to the optical path axis direction.

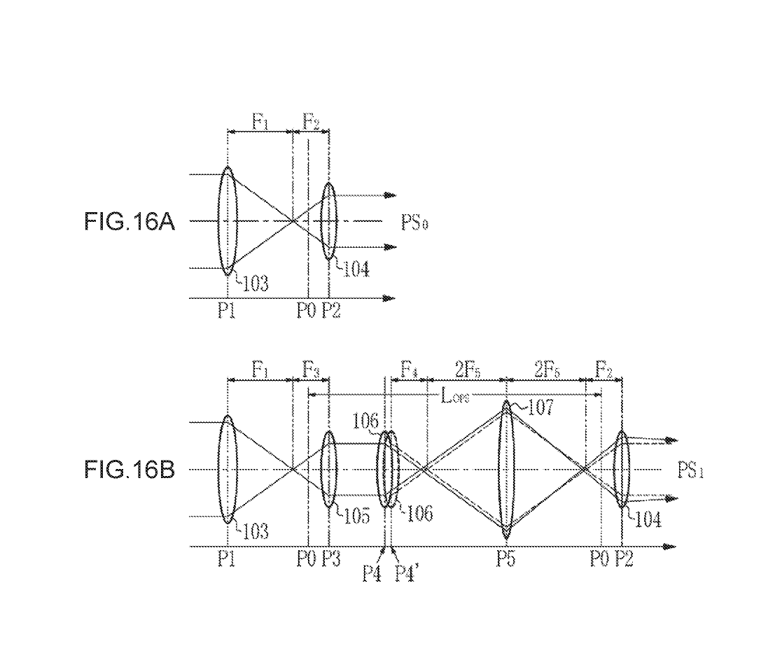

FIG. 16A illustrates a positional relation between the first and second condensing lenses 103 and 104. P1 represents a position of the first condensing lens 103. P2 represents a position of the second condensing lens 104. P0 represents a position of the beam splitter 101. It is assumed that F₁ represents a focal distance of the first condensing lens 103, and F₂ represents a focal distance of the second condensing lens 104. The position P2 is set such that an optical path length between the position P and the position P2 becomes equal to “F₁+F₂”. This means that the first lens group is a collimate optical system. It is also possible to allow the first lens group to be a non-collimate optical system by shifting the position P2 from a position satisfying the collimate condition.

In FIG. 15, the first to fourth high reflective mirrors 102a to 102d and a second lens group including third to fifth condensing lenses 105 to 107 constitute a delay optical path. Each of the first to fourth high reflective mirrors 102a to 102d is a planar mirror in which a high reflective film is formed on a surface thereof. The substrates of the first to fourth high reflective mirrors 102a to 102d are made of synthetic quartz or calcium fluoride (CaF₂). A high-reflective film is a dielectric multilayer film such as a film containing fluoride, for example.

The first to fourth high reflective mirrors 102a to 102d are disposed such that the light reflected by the beam splitter 101 of the pulse laser light PL is reflected sequentially at a high level and is made incident on the beam splitter 101 again. The third and fourth condensing lenses 105 and 106 are disposed between the beam splitter 101 and the first high reflective mirror 102a. The fifth condensing lens 107 is disposed between the second high reflective mirror 102b and the third high reflective mirror 102c.

The fourth condensing lens 106 is held by a uniaxial stage 106a. The uniaxial stage 106a enables the fourth condensing lens 106 to move in the V axis direction that is an optical path axis direction. The divergence angle θₙ of the n-circulation light PSₙ (n≥1) can be adjusted by adjusting the position of the fourth condensing lens 106 with respect to the optical path axis direction.

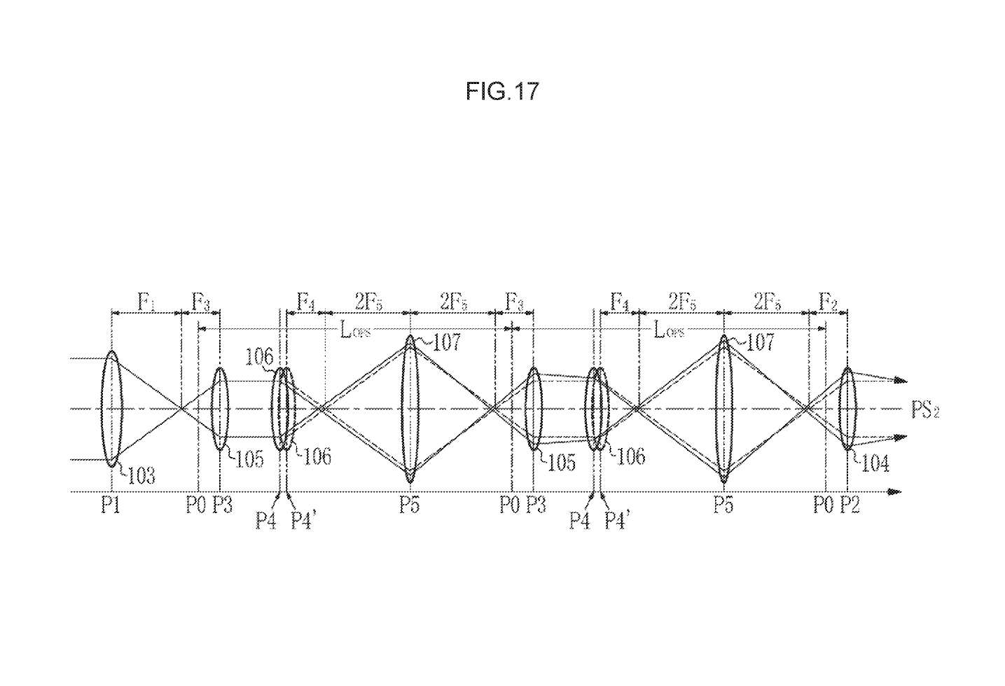

FIGS. 16B and 17 illustrate a positional relation among the first to fifth condensing lenses 103 to 107. P3 represents a position of the third condensing lens 105. P4 represents a position of the fourth condensing lens 106. P5 represents a position of the fifth condensing lens 107. It is assumed that F₃ represents a focal distance of the third condensing lens 105, F₄ represents a focal distance of the fourth condensing lens 106, and F₅ represents a focal distance of the fifth condensing lens 107. The position P3 is set such that an optical path length between the position P1 and the position P3 becomes equal to “F₁+F₃”.

P4′ represents a position of the fourth condensing lens 106 when the delay optical path satisfies the collimate condition. The position P5 is set such that an optical path length between the position P4′ and the position P5 becomes equal to “F₄+2F₅”, an optical path length between the position P2 and the position P5 becomes equal to “F₂+2F₅”, and an optical path length between the position P3 and the position P5 becomes equal to “F₃+2F₅”. The position of the fourth condensing lens 106 is adjusted in the optical path axis direction by the uniaxial stage 106a such that the delay optical system becomes a non-collimate optical system, that is, the position P4 becomes a position shifted from the position P4′.

Further, the beam splitter 101, the first to fourth high reflective mirrors 102a to 102d, and the first to fifth condensing lenses 103 to 107 are disposed such that the optical path axis of the zero-circulation light PS₀ output from the OPS 100 and the optical path axis of the one-circulation light PS₁ coincide with each other. This means that in the second embodiment, all of the optical path axes of the plurality of pulse light beams PSₙ output from the OPS 100 coincide with each other.

In FIGS. 16B and 17, L_{OPS} represents an optical path length of the delay optical path. The optical path length L_{OPS} satisfies the relationship of Expression 2 described above. The pulse width ΔDT of the stretched pulse laser light PT generated by the OPS 100 satisfies the relationship of Expression 3 described above.

3.2 Operation

Next, operation of the laser system according to the second embodiment will be described. First, the pulse laser light PL output from the solid-state laser device 3 is made incident on the beam splitter 101 via the first condensing lens 103. Part of the pulse laser light PL made incident on the beam splitter 101 passes through the beam splitter 101, and is made incident on the second condensing lens 104. The light emitted from the second condensing lens 104 is output from the OPS 100 as zero-circulation light PS₀. As illustrated in FIG. 16A, the zero-circulation light PS₀ is collimate light.

Reflected light reflected by the beam splitter 101, of the pulse laser light PL having been made incident on the beam splitter 101, enters the delay optical path. The reflected light that entered the delay optical path is made incident on the beam splitter 101 again via the third condensing lens 105, the fourth condensing lens 106, the first high reflective mirror 102a, the second high reflective mirror 102b, the fifth condensing lens 107, the third high reflective mirror 102c, and the fourth high reflective mirror 102d. Part of the light made incident on the beam splitter 101 is reflected by the beam splitter 101 and is made incident on the second condensing lens 104. The light emitted from the second condensing lens 104 is output from the OPS 100 as one-circulation light PS₁. As illustrated in FIG. 16B, the one-circulation light PS₁ is non-collimate light, and is converged at a position far from the OPS 100. This means that the beam waist position w₁ of the one-circulation light PS₁ is located far from the OPS 100.

Transmitted light that passed through the beam splitter 101, of the light having been made incident on the beam splitter 101, enters the delay optical path again, circulates through the delay optical path once again, and is made incident on the beam splitter 101 again. Part of the light made incident on the beam splitter 101 is reflected by the beam splitter 101, and is output as two-circulation light PS₂ from the OPS 100 via the second condensing lens 104. FIG. 17 illustrates the two-circulation light PS₂ output from the OPS 100. The beam waist position w₂ of the two-circulation light PS₂ is closer to the OPS 100 side than the beam waist position w₁ of the one-circulation light PS₁.

Subsequently, circulation of light on the delay optical path is repeated. Thereby, pulse light is output sequentially from the OPS 100 as three-circulation light PS₃, four-circulation light PS₄, and the like. As the circulation count n on the delay optical path increases, the beam waist position wₙ of the output light from the OPS 100 is closer to the OPS 100 side. The subsequent operation is the same as that of the laser system 50 of the first embodiment. Accordingly, the description thereof is omitted.

3.3 Effect

The laser system of the second embodiment is able to lower the coherence of output light and suppress generation of ASE light, as in the case of the first embodiment. Moreover, in the laser system of the second embodiment, by adjusting the positions of the second condensing lens 104 and the fourth condensing lens 106, it is possible to adjust the divergence angle θₙ of the n-circulation light PSₙ and the beam waist position wₙ.

In the second embodiment, the first lens group is provided for adjusting the divergence angle θ₀ of the zero-circulation light PS₀. However, the first lens group is not an indispensable constituent element. Layout of the high reflective mirrors and the condensing lenses constituting the delay optical system is changeable as appropriate.

### 4. Example of Disposing OPS in Post Stage of Amplifier

In the laser systems according to the first and second embodiments, an OPS is disposed between the solid-state laser device 3 and the amplifier 30. It is also possible to dispose another OPS in the post stage of the amplifier 30. The OPS disposed between the solid-state laser device 3 and the amplifier 30 corresponds to a first optical pulse stretcher. The OPS disposed in the post stage of the amplifier corresponds to a second optical pulse stretcher.

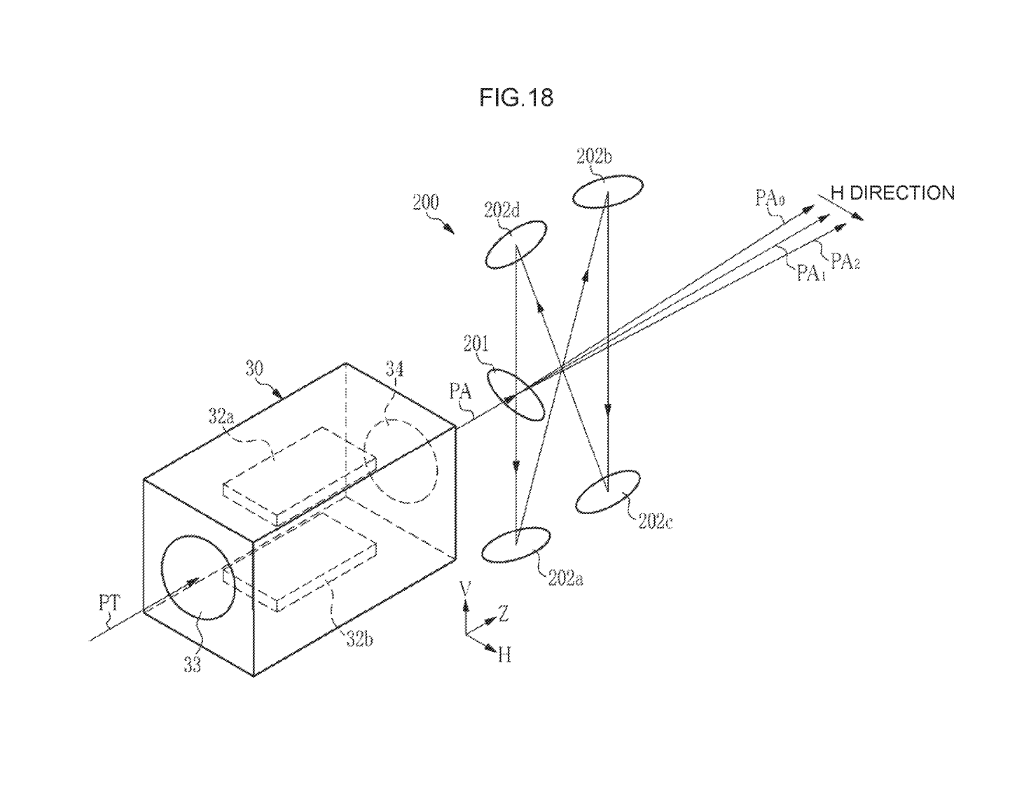

FIG. 18 is a perspective view illustrating the amplifier 30 and an OPS 200 disposed in the post stage of the amplifier 30. The OPS 200 includes a beam splitter 201 and first to fourth concave mirrors 202a to 202d. The OPS 200 has the same configuration as that of the OPS 40 illustrated in FIG. 4. All of the first to fourth concave mirrors 202a to 202d have the same radius of curvature. An optical path length of the delay optical path configured of the first to fourth concave mirrors 202a to 202d is eight times longer than the focal distance F. The fourth concave mirror 202d is disposed at a position where it is slightly turned with the Z direction being the turning axis, relative to the position satisfying the collimate condition.

Output light PA output from the amplifier 30 is spatially resolved in the H direction by the OPS 200. In a plurality of output light beams PAₙ (n=0, 1, 2, . . . ) output from the OPS 200, the emission angle thereof is changed in the H direction according to the circulation count n on the delay optical path in the OPS 200. As a result, coherence of the output light from the laser system is further lowered.

It is preferable that the fourth concave mirror 202d is turned within a range that the output light from the laser system does not affect the optical system of the exposure device. Further, any of the aforementioned OPSs 60, 80, 90, and 100 is applicable, in place of the OPS 200. Furthermore, a plurality of OPSs may be disposed in the post stage of the amplifier 30. For example, it is possible to dispose the OPS 40 in the post stage of the OPS 200 disposed in the post stage of the amplifier 30, to thereby resolve the output light PA from the amplifier 30 in the H direction and the V direction.

### 5. Modifications of Amplifier

While the amplifier 30 illustrated in FIG. 6 is applied to the laser system according to the first and second embodiments, amplifiers may have various configurations.

5.1 First Modification

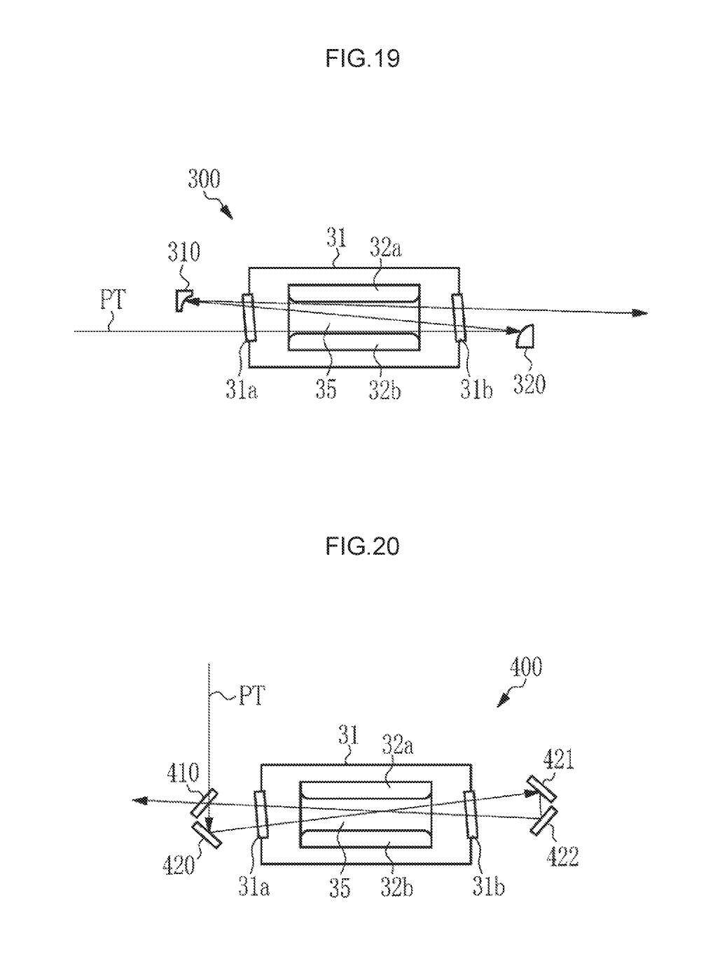

FIG. 19 illustrates a configuration of an amplifier 300 according to a first modification. The amplifier 300 includes the concave mirror 310 and the convex mirror 320, instead of the rear mirror 33 and the output coupling mirror 34 in the configuration of the amplifier 30 illustrated in FIG. 6. The concave mirror 310 and the convex mirror 320 are disposed such that the stretched pulse laser light PT passes through the discharge space 35 between the pair of discharge electrodes 32a and 32b three times and the beam is expanded. The other parts of the configuration of the amplifier 300 are similar to those of the amplifier 30. The amplifier 300 is referred to as a multipath amplifier.

In the case of applying the amplifier 30 as described above, the beam expander 20 may be omitted.

5.2 Second Modification

FIG. 20 illustrates a configuration of an amplifier 400 according to a second modification. In FIG. 20, the amplifier 400 includes the laser chamber 31, an output coupling mirror 410, and high reflective mirrors 420 to 422. The high reflective mirrors 420 to 422 are planar mirrors. The amplifier 400 may also include a high reflective mirror for introducing the stretched pulse laser light PT to the high reflective mirror 420.

The output coupling mirror 410 and the high reflective mirrors 420 to 422 constitute a ring resonator. In the amplifier 400, the stretched pulse laser light PT repeatedly travels through the output coupling mirror 410, the high reflective mirror 420, the discharge space 35, the high reflective mirror 421, the high reflective mirror 422, and the discharge space 35 in this order, and is amplified.

It is also possible to have a configuration in which the high reflective mirrors 420 to 422 are concave mirrors, and a divergence angle varies each time incident light to the resonator circulates through the inside of the resonator. In that case, the beam waist position of the output light from the output coupling mirror 410 is changed in the optical path axis direction according to the circulation count in the resonator. In this way, the amplifier 400 may have a function of lowering the coherence of the output light.

While the laser system in each of the embodiments described above uses the solid-state laser device 3 as a master oscillator, the master oscillator is not limited to a solid-state laser device. Another laser device such as an excimer laser may be used.

The description provided above is intended to provide just examples without any limitations. Accordingly, it will be obvious to those skilled in the art that changes can be made to the embodiments of the present disclosure without departing from the scope of the accompanying claims.

The terms used in the present description and in the entire scope of the accompanying claims should be construed as terms “without limitations”. For example, a term “including” or “included” should be construed as “not limited to that described to be included”. A term “have” should be construed as “not limited to that described to be held”. Moreover, a modifier “a/an” described in the present description and in the accompanying claims should be construed to mean “at least one” or “one or more”.

What is claimed is:

1. A laser system comprising:
(A) a laser device configured to output pulse laser light; and
(B) a first optical pulse stretcher including a delay optical path for stretching a pulse width of the pulse laser light, the first optical pulse stretcher being configured to change a beam waist position of circulation light that circulates through the delay optical path and is output therefrom, in an optical path axis direction according to a circulation count.

2. The laser system according to claim 1, wherein
when the circulation light is condensed by an ideal lens, a light condensing position of the circulation light is changed in the optical path axis direction according to the circulation count.

3. The laser system according to claim 1, wherein
the delay optical path includes a plurality of concave mirrors, and
at least one concave mirror of the plurality of the concave mirrors has a curvature different from curvatures of rest of the concave mirrors.

4. The laser system according to claim 1, wherein
the delay optical path includes a plurality of concave mirrors, and
at least one concave mirror of the plurality of the concave mirrors is moved from a position satisfying a collimate condition, in a direction of changing an optical path length of the delay optical path.

5. The laser system according to claim 1, wherein
the delay optical path includes a plurality of concave mirrors, and
the delay optical path is provided with a lens configured to change a divergence angle of the circulation light and output the circulation light.

6. The laser system according to claim 1, wherein
the delay optical path includes a plurality of high reflective mirrors and a plurality of condensing lenses, and
at least one condensing lens of the plurality of the condensing lenses is moved in an optical path axis direction from a position satisfying a collimate condition.

7. The laser system according to claim 1, wherein
an optical path length of the delay optical path is equal to or longer than a temporally coherent length of the pulse laser light.

8. The laser system according to claim 1, further comprising
(C) an amplifier configured to amplify stretched pulse laser light output from the first optical pulse stretcher.

9. The laser system according to claim 8, wherein
the amplifier includes a Fabry-Perot resonator or a ring resonator.

10. The laser system according to claim 8, wherein
the amplifier is a multipath amplifier.

11. The laser system according to claim 8, further comprising
(D) a beam expander disposed between the first optical pulse stretcher and the amplifier, wherein
the beam expander expands a beam diameter of the stretched pulse laser light so as to conform to a width of a discharge space of the amplifier.

12. The laser system according to claim 8, further comprising
(E) a second optical pulse stretcher configured to stretch a pulse width of output light from the amplifier.

13. The laser system according to claim 1, wherein
L_{OPS}=c·ΔD (a)
is satisfied, where ΔD represents a pulse width of the pulse laser light, L_{OPS} represents an optical path length of the delay optical path, and c represents velocity of light.

14. The laser system according to claim 8, wherein
the amplifier is a Fabry-Perot resonator, and
ΔDT≥Lₐₘₚ/c (b)
is satisfied, where ΔDT represents a pulse width of the stretched pulse laser light, Lₐₘₚ represents an optical path length of the Fabry-Perot resonator, and c represents velocity of light.

15. The laser system according to claim 1, wherein
the laser device is a solid-state laser device.
